(19) United States
(12) Patent Application Publication
(10) Pub. No.: US 2004/0253336 A1
(43) Pub. Date: Dec. 16, 2004

(54) Extruder with heating elements

(75) Inventors: Siegfried Chszaniecki, Hannover (DE); Gregor Chszaniecki, Hannover (DE)

Correspondence Address: COHEN, PONTANI, LIEBERMAN & PAVANE, 551 FIFTH AVENUE, SUITE 1210, NEW YORK, NY, 10176, US

(73) Assignee: Berstorff GmbH

(21) Appl. No.: 10/827,059

(22) Filed: Apr. 19, 2004

Related U.S. Application Data
(63) Continuation of application No. PCT/EP02/10575, filed on Sep. 20, 2002.

(30) Foreign Application Priority Data
Oct. 18, 2001 (DE) 101 51 432.8

(51) Int. Cl. B29B 9/02

(52) U.S. Cl. 425/311; 425/378.1

(57) ABSTRACT

An extruder includes a barrel having at least one axial bore extending to a downstream end of the barrel, a cutting plate of a granulating unit, received against a contact surface at the downstream end, and a plurality of heating elements in the barrel in the immediate vicinity of the contact surface. The heating elements are preferably heating cartridges which are received in two pairs of parallel bores at right angles to each other, thereby forming a square in a plane transverse to the axial bore.

The invention pertains to an extruder according to the introductory clause of claim 1.

In an extruder with a cutting plate for a granulating unit designed as an underwater granulator, the problem occurs that the temperature of the cutting plate is decreased to such an extent by the cooling action of the water that the extrudate cools down too much in the extruder die. As a result, the viscosity of the extrudate increases, and in the worst case the extrudate solidifies prematurely. To prevent this, the cutting plate is usually heated. For this purpose, it is the standard practice according to the state of the art to temper the cutting plate of an extruder directly by the use of heat-exchange media. In the conventional case, the cutting plate of the underwater granulator is attached to the barrel of the extruder by way of a standardized head connection and a special adapter.

The disadvantage of this tempering according to the state of the art is that, when the cutting plate is to be removed, the connections for the heat-exchange medium must be detached from the cutting plate. The assembly and disassembly work thus involved makes it difficult to manage the tempering process. Depending on the design, the indirectly heated cutting plate can also be held in place by an additional ring, which must be heated separately. To remove the cutting plate, this ring must also be detached.

The invention is based on the task of creating an extruder of the general type in question which is simple in design and easy to manage.

This task is accomplished by an extruder with the features of claim 1.

In the inventive extruder, the cutting plate is connected directly to the end of the barrel on the downstream side of the extruder. This makes it possible to integrate the heating elements into the barrel. The heating elements in the barrel are located in the immediate vicinity of the contact surface between the barrel and the cutting plate, so that the best possible thermal transfer is achieved between the heating elements and the cutting plate. When a standardized head connection and an adapter are used to attach the cutting plate of the underwater granulator to the barrel of the extruder, however, the head connection and the adapter create so much additional thermal resistance that it would be impossible to heat the cutting plate indirectly via the barrel.

The barrel is preferably built up in modular fashion out of cylindrical axial segments. This simplifies production, especially with respect to the two axial bores which accommodate the screws. In addition, the modular design of the barrel provides a certain flexibility without causing the length of the extruder to increase to any significant extent. The individual modules can be designed to deal specifically with the individual phases of the extrusion process.

The heating elements are advantageously designed as heating cartridges. Without the high cost of a heat-exchange medium, heating is accomplished very directly and locally in this way, and it can also be controlled very flexibly.

In a preferred embodiment of the invention, the heating cartridges are installed in continuous bores passing all the way through the barrel. If one of these heating cartridges fails, it can be easily removed by knocking it out of its continuous bore. The heating cartridges are preferably arranged to form a polygon extending around the barrel. This arrangement offers the advantage of a uniform distribution of the heating power around the circumference, similar to that achieved with a star-like arrangement, but it also avoids blind holes, from which the heating cartridges would have to be pulled when it is necessary to replace them. If a cartridge were to become stuck in its blind hole, the pulling unit could break and the heating cartridge would have to be drilled out.

In an advantageous embodiment of the invention, two screws are mounted in overlapping, axially oriented bores in the barrel of the extruder. With respect to the transport direction of the screws, a channel is present downstream from the bores. The outlet-side cross section of this channel is congruent with the cross section of the feed opening of the cutting plate. Because the outlet cross section of the barrel is the same size as the inlet cross section of the cutting plate, there is no need for an adapter. The cutting plate can be connected directly to the barrel without forming flow-resisting steps or shoulders in the channel cross section at the contact surface between the barrel and the cutting plate and thus without causing any significant loss of flow. The direct connection between the cutting plate and the barrel, however, is necessary to ensure good heat transfer from the heating elements to the cutting plate. Integration of the heating elements into the barrel is desirable only if the heat can be transferred effectively to the cutting plate, that is, only if there is a direct connection between the cutting plate and the barrel.

The overlapping, axially oriented bores preferably extend all the way to the inlet-side part of the last barrel segment of a modular barrel consisting of axial barrel segments. The screws in this last barrel segment have a shape which causes the pressure to build up in the extrudate as they rotate. The channel following after the bores is located in the outlet-side part of the last barrel segment. This design offers the advantage of especially low pressure losses.

In an advantageous embodiment of the invention, the barrel has a mounting recess, in which at least half of the volume of the cutting plate is accommodated. This has the advantage that the cutting plate is held firmly in position; and in addition, the heat can flow to the plate not only in the axial direction but also in the radial direction via the lateral surface of the cutting plate.

The extruder is preferably used to granulate thermoplastic compositions as part of compounding processes.

An embodiment of the invention is illustrated in the drawings:

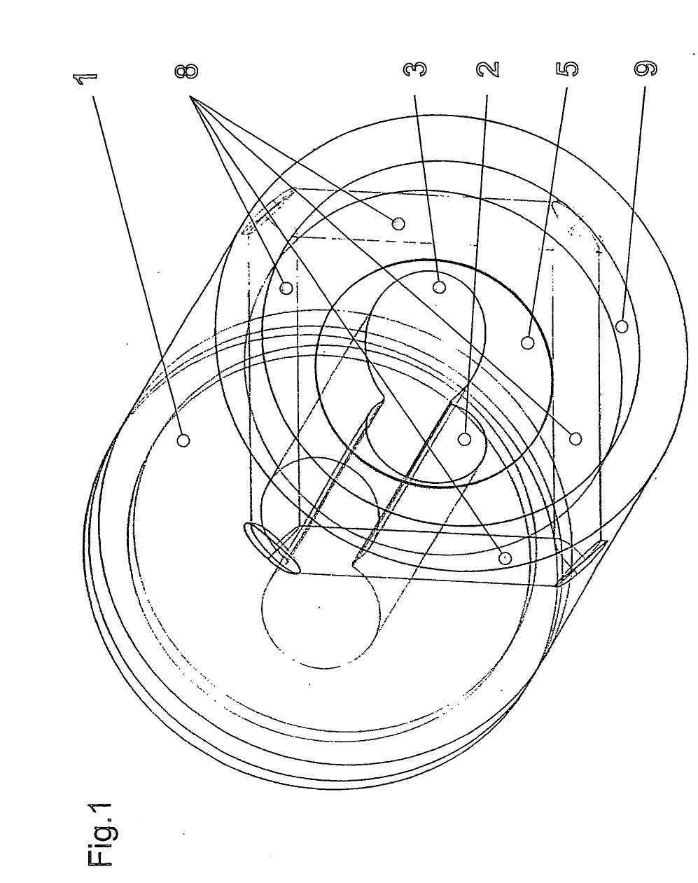

FIG. 1 is perspective view proceeding from the end of the barrel, showing a barrel segment with four continuous bores arranged in a square to receive heating cartridges and with two overlapping, axially oriented bores to hold the screws, these bores lead to a channel which serves to adapt the cross section; and

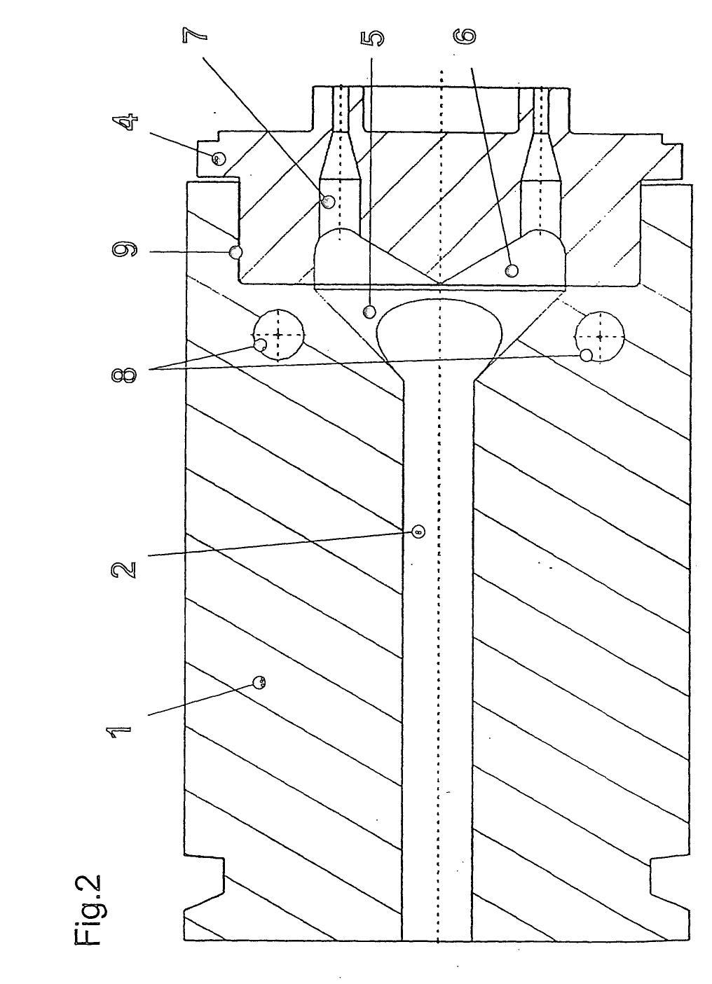

FIG. 2 shows a barrel segment similar to that of FIG. 1 in a cross-sectional plane containing the axis of the barrel and passing through two of the four continuous bores arranged in a square to hold the heating cartridges, this plane also passing through two overlapping, axially oriented bores leading to a channel which adapts the outlet-side cross section of this barrel segment, a cutting plate also being connected to the barrel segment.

Two overlapping, axially oriented bores 2, 3, which accept two screws (not shown), extend through a barrel segment 1 of an extruder. In the view according to FIG. 2, the screws convey from left to right. The barrel segment 1 shown here is the last segment of an extruder designed as a series of cylindrical modules (not shown). A cutting plate 4 is connected to the outlet side of the barrel segment 1—on the right in FIG. 2. At the end of the barrel segment 1 connected to the cutting plate 4, the bores 2, 3 expand conically to form a channel 5, which provides the end surface of the barrel with a circular cross section. The outlet cross section of the channel 5 of the barrel segment 1 and the inlet cross section of a flow-through channel system 6 of the cutting plate 4 are congruent. The cross section of the flow-through channel system 6 tapers down in the transport direction toward the bores 7 passing through the cutting plate 4, which are themselves also tapered. Upon emergence from these bores 7, the extrudate forms a strand, which is cut into a granulate by a knife (not shown). Four continuous bores 8 arranged to form a square are provided in the immediate vicinity of the outlet-side end of the barrel segment 1 to hold heating cartridges (not shown). The heating elements are installed in optimal fashion to ensure the best possible heat transfer to the cutting plate. The contact surface between the last barrel segment 1 and the cutting plate 4 represents a certain thermal resistance. How effectively the heat is conducted here depends on the size of the contact surface. To make the contact surface as large as possible, the last barrel segment 1 has on its outlet side a mounting recess 9, in which at least half of the cutting plate 4 is accommodated. As a result of this design measure, the heat can flow into the cutting plate 4 not only axially but also radially via the lateral surface of the plate. The arrangement of the heating elements has the goal of using as much of the contact surface as possible for the uniform transfer of heat to the cutting plate 4. The heating elements are therefore mounted in radially outer positions, almost at the radius of the mounting recess 9, so that short thermal conduction routes are obtained and a good heat-transfer connection can thus also be established for the rabbet of the last barrel segment 1 comprising the receiving opening 9 for the cutting plate 4. The continuous bores for the heating elements are very close axially to the end surface of the recess. The distance between the continuous bores and the end surface of the recess is less than the diameter of a bore. As a result of the favorable positioning of the heating elements with respect to the overall contact surface and the short distance between the heating elements and the contact surface, the temperature control process suffers from very low thermal inertia. The installation of the heating elements in the continuous bores makes it possible to replace a defective heating element very quickly, because—even if an element becomes stuck in its bore—it can be knocked out of the bore by a few blows with a hammer.

### List of Reference Numbers

1 barrel segment

2 bore

3 bore

4 cutting plate

5 channel

6 flow-through channel system

7 bore

8 continuous bore

9 mounting recess

1-9: (cancelled).

10: An extruder comprising:
a barrel having at least one axial bore extending to a downstream end of the barrel, said downstream end having a contact surface;
a cutting plate of a granulating unit, said cutting plate being received against said contact surface; and
a plurality of heating elements in said barrel in the immediate vicinity of said contact surface.

11: An extruder as in claim 10 wherein the barrel comprises a plurality of axial barrel segments.

12: An extruder as in claim 10 wherein the heating elements are heating cartridges.

13: An extruder as in claim 12 wherein said barrel has continuous bores passing therethrough, said heating cartridges being received in said bores.

14: An extruder as in claim 13 wherein said continuous bores are arranged in parallel pairs at right angles to each other to form a square in a plane transverse to said at least one axial bore.

15: An extruder as in claim 10 wherein said at least one axial bore comprises a pair of overlapping axial bores which open in a channel having a cross section at said contact surface, said cutting plate having a feed opening with a cross section which is congruent with said cross-section of said channel.

16: An extruder as in claim 15 comprising a plurality of axial barrel segments through which said axial bores extend from an inlet side of said barrel to said contact surface, said channel being located wholly in the barrel segment at the contact surface.

17: An extruder as in claim 10 said barrel comprises a mounting recess in which said contact surface is located, said cutting plate having a volume, at least half of said volume being received in said recess.

18: An extruder as in claim 17 wherein said recess and said plate each have radially facing surfaces which are in contact with each other.
